(19) United States
(12) Patent Application Publication
(10) Pub. No.: US 2003/0063131 A1
(43) Pub. Date: Apr. 3, 2003

(54) Picture moving and positioning method in image processing software

(75) Inventor: Car-Lai Ma, Taipei (TW)

Correspondence Address: BACON & THOMAS, PLLC, 625 SLATERS LANE, FOURTH FLOOR, ALEXANDRIA, VA, 22314

(73) Assignee: Tiger Color Inc., Taipei (TW)

(21) Appl. No.: 09/968,914

(22) Filed: Oct. 3, 2001

(51) Int. Cl. G09G 5/00

(52) U.S. Cl. 345/838

(57) ABSTRACT

A picture moving and positioning method in an image processing software installed in a computer, after the image processing software is activated, the method comprising the steps of showing a desktop for placing a plurality of thumbnails on a screen of the computer; and showing at least one picture management object on the desktop, each picture management object having a plurality of sorted picture frames wherein as the thumbnails being moved from the desktop to the picture management object by manipulating input means connected to the computer, the thumbnails are sequentially embedded into empty ones of the picture frames of the picture management object.

### FIELD OF THE INVENTION

The present invention relates to image processing and more particularly to a picture moving and positioning method in image processing software with improved characteristics.

### BACKGROUND OF THE INVENTION

Electronic technologies have known a rapid and a spectacular development leading to an increasing performance of computers and peripherals thereof. Further, a variety of inexpensive software are continuously available. This in turn makes computers and peripherals more popular among consumers for facilitating daily life, learning, and so on. For taking advantage of such trend, many AV product manufacturers endeavor to develop digitized products for attracting the newly formed many computer consumers. For example, in the case of digital camera, manufacturers usually give free image processing software when user buys a digital camera, thereby attracting more consumers to buy their products. By utilizing the image processing software, user may read the fetched digital image representation from digital camera and show the same from screen of a connected computer or TV. Alternatively, user may edit image therein. This has the benefits of saving cost of printing photographs, customizing digital image representation, saving storage space and related resources, and so forth.

Besides, the Internet has been widely used throughout the world in recent years. User may browse pictures and text contained in pages of Web site via a network browser connected to computer. Also, user may download preferred pictures from the browser and store the same on memory of computer for future use via the Internet.

Conventionally, user may easily obtain a large number of digital image representations via a digital camera (or browser) without spending money on printing photographs or obtaining pictures. This also can save precious data storage space. However, user still has to spend excessive time and effort on systematically editing and modifying the larger number of digital image representations. Typically, user has to name photographs (or pictures) individually in an image processing software (e.g., album software) prior to storing each photograph (or picture) in related album or root directory based on a classification of photographs (or pictures). If user desires to edit the photographs (or pictures) again, above procedure has to be repeated. In view of above, the editing procedure is tedious, time-consuming, and laborious. It contradicts the trend of providing a user friendly operating environment. Thus improvement exists.

### SUMMARY OF THE INVENTION

The present invention is directed to solve the problems associated with the prior art as stated in the background section of the specification. In brief, the editing procedure of classifying or editing photographs (or pictures) in image processing software is tedious, time-consuming, and laborious. It is therefore an object of the present invention to provide a picture moving and positioning method in an image processing software installed in a computer. After the image processing software is activated, the method comprises the steps of a) showing a desktop for placing a plurality of thumbnails on a screen of the computer; and b) showing at least one picture management object on the desktop, each picture management object having a plurality of sorted picture frames wherein as the thumbnails being moved from the desktop to the picture management object by manipulating input means connected to the computer, the thumbnails are sequentially embedded into empty ones of the picture frames of the picture management object.

In one aspect of the present invention, the method enables a user to download pictures from the Internet or digital camera based on needs by executing image processing software and review the same prior to sequentially embedding thumbnails into empty picture frames of picture management object. By utilizing this, it is possible of easily and efficiently editing pictures, resulting in both time and labor saving as well as providing a user friendly operating environment with respect to picture classification or album editing.

In another aspect of the present invention, when the input means is manipulated to click the thumbnail in the picture frame, the image processing software directly reads the graphics file from a location corresponding to the thumbnail by referring the index table, and maximizes and shows the read graphics file in a browsing window available by the image processing software.

The above and other objects, features and advantages of the present invention will become apparent from the following detailed description taken with the accompanying drawings.

### BRIEF DESCRIPTION OF THE DRAWINGS

FIG. 1 illustrates a screen display of a running image processing software according to a preferred embodiment of the invention;

FIG. 2 illustrates a screen display of an enabled picture management object of FIG. 1;

FIG. 3 illustrates a screen display of prior to embedding thumbnails to picture management object;

FIG. 4 is a flow chart illustrating a process of moving thumbnails to picture management object by the image processing software of the invention; and

FIG. 5 illustrates a screen display of after thumbnails have been embedded into picture management object.

### DETAILED DESCRIPTION OF THE PREFERRED EMBODIMENTS

The present invention is directed to a positioning method in image processing software. Particularly, such image processing software is installed in a computer. Once image processing software is running, a desktop is shown on screen of computer for placing a plurality of thumbnails. Thumbnail being placed on the desktop may be a minimized representation of a picture downloaded from the Internet (or digital camera) via computer. Alternatively, thumbnail may be a minimized representation of a picture read from a storage device (e.g., hard disk or floppy disk). Also, at least one picture management object (e.g., so-called electronic album) may be present on desktop. A plurality of sorted picture frames are arranged in each picture management object. Picture frames are provided for receiving thumbnails. With this arrangement, user may review thumbnails shown on desktop prior to classifying the same based on requirement. Next, user may manipulate an input device (e.g., mouse or sensor pen) connected to computer for clicking each of thumbnails and moving the same to an associated picture management object. As a result, thumbnails are sequentially embedded into empty picture frames of a picture management object.

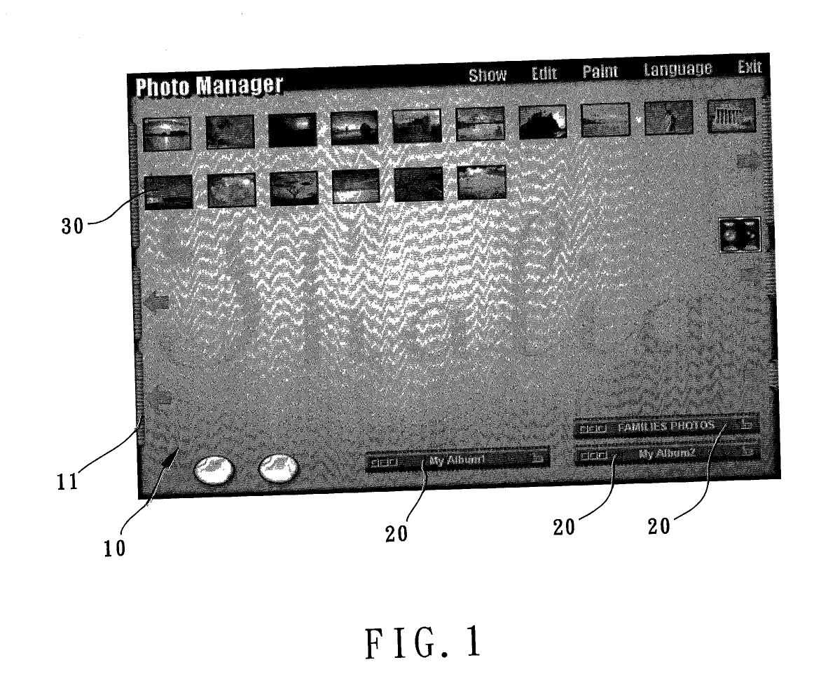

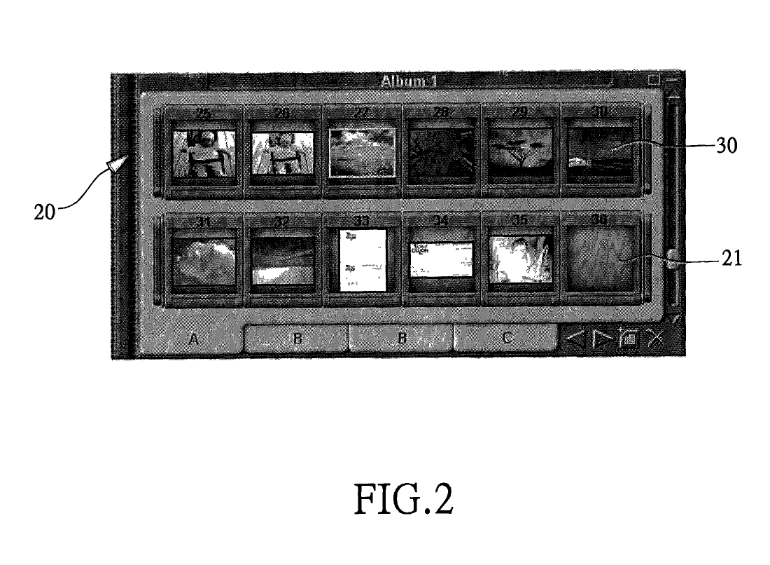

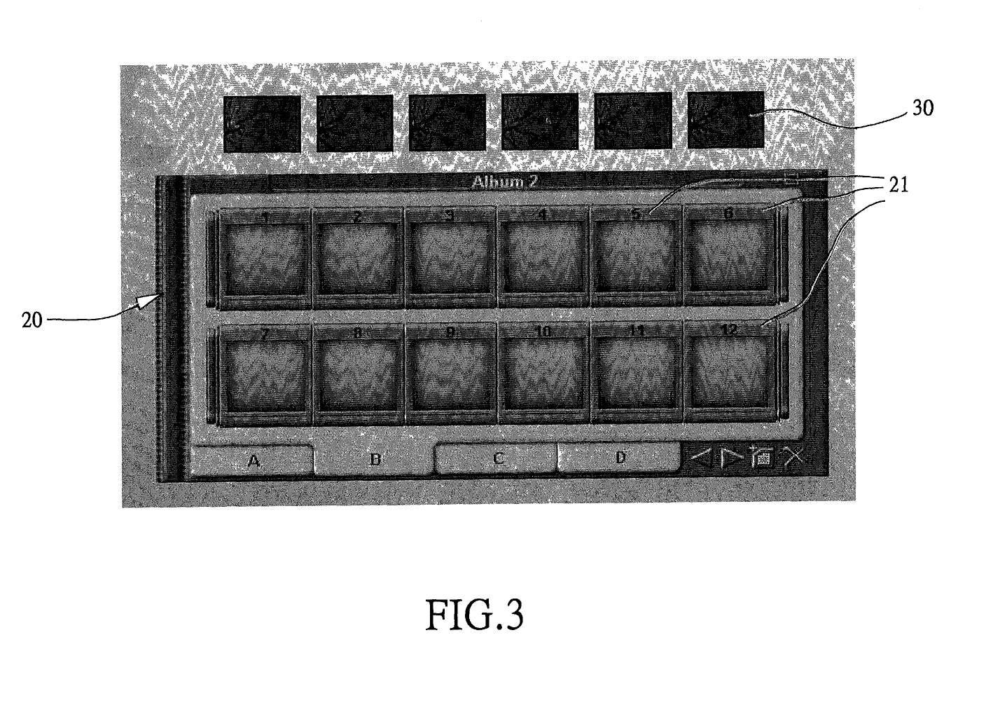

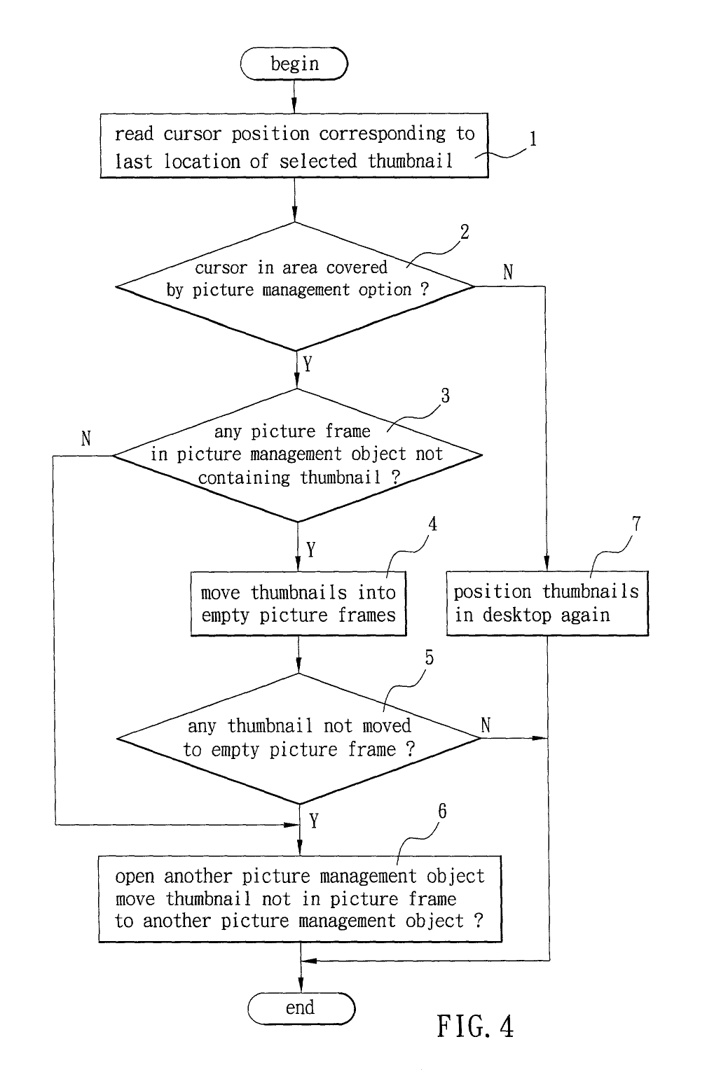

In a preferred embodiment of the invention as shown in FIG. 1, image processing software is installed in a computer. When the image processing software is running, a desktop 10 is shown on screen of computer for placing a plurality of thumbnails 30. Also, at least one function key 11 is provided thereon. User can select one desired function key 11 by clicking mouse for opening at least one picture management object 20 (e.g., electronic album) on desktop 10. User may name each of albums (e.g., album 1, album 2, families photos, and so on) in establishing each picture management object 20 based on requirement. A plurality of sorted picture frames 21 are arranged in each picture management object 20 (FIG. 2). The size of each picture frame 21 is suitably designed to receive a thumbnail 30. Hence, user may select at least one thumbnail 30 by clicking mouse. For example, click left button of mouse to sequentially select each thumbnail 30. Alternatively, continuously press left button of mouse and move mouse to form a block to select thumbnails 30 (FIG. 3). In moving thumbnails 30 to a picture management object 20, the image processing software of the invention may perform the following steps for sequentially embedding thumbnails 30 into empty picture frames 21 of a picture management object 20 as illustrated in FIG. 4.

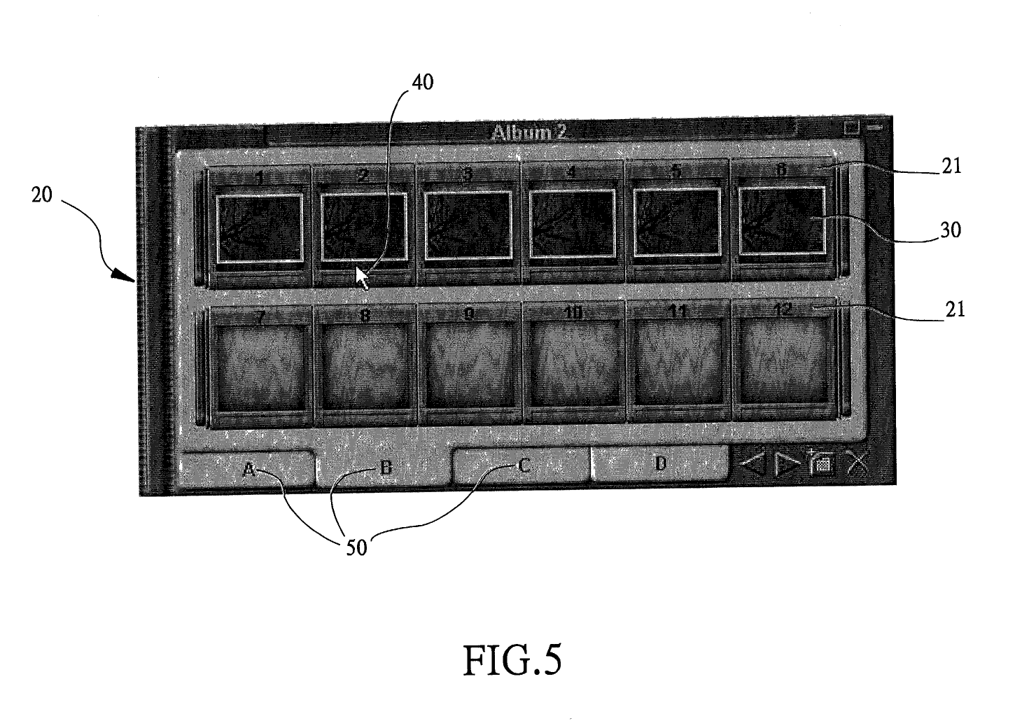

In step 1, detect and read the last location of selected thumbnail 30 by clicking mouse, i.e., the location of cursor 40 as left button of mouse is released (FIG. 5). In step 2, determine whether cursor 40 is within the area covered by picture management object 20 when thumbnail 30 is moved to the last location. If yes, the process goes to step 3. Otherwise, the process goes to step 7.

In step 3, determine whether there is any of picture frames 21 in picture management object 20 not containing thumbnail. If yes, the process goes to step 4. Otherwise, the process jumps to step 6.

In step 4, move clicked thumbnails 30 to picture management object 20 in which thumbnails 30 are sequentially embedded into empty picture frames 21 of a picture management object 20 (FIG. 5).

In step 5, determine whether there is clicked thumbnail 30 not being embedded to empty picture frame 21. If yes, the process goes to step 6. Otherwise, the process ends.

In step 6, open another picture management object 20. Next, move the clicked thumbnail 30, not been embedded to empty picture frame 21, to another picture management object 20. Then sequentially embed the same into picture frame 21 of another picture management object 20. The process ends accordingly.

In step 7, position thumbnails 30 in desktop 10 again. The process ends accordingly. Hence, user can review thumbnail 30 again. Further, user can repeat above processes for editing based on requirement.

In an another preferred embodiment of the invention as shown in FIG. 5, picture management object 20 is an electronic album. When the album is opened, there are at least one page 50 (e.g., page 50 with labeled A, B, C, and D) available for receiving picture. A plurality of sorted picture frames 21 are provided in each page 50. Each of thumbnails 30 is received in picture frame 21. In sequentially moving thumbnails 30 into a page 50, after all thumbnails 30 are embedded into picture frames 21 of page 50, another album 50 may be opened. By repeating above procedure, the album can have at least one page 50 with pasted pictures for user viewing.

Moreover, in above embodiment of the invention, when user click function key 11 of image processing software to establish picture management object 20 in desktop 10, an index table will be created for picture management object 20. Hence, as thumbnail 30 moved to picture management object 20 for being received therein, information about graphics file (e.g., file name, root directory, etc.) corresponding to thumbnail 30 will be stored in index table. In such a manner, when user classifies graphics files from various hard disks or root directories based on requirement and then move the classified graphics files to picture management object, there is no need to edit locations of graphics files again. When user clicks thumbnail in picture frame 21, image processing software may directly read graphics file from a location corresponding to thumbnail by referring the index table. Next, maximize and show the read graphics file in a browsing window available by image processing software.

In view of above, the method taught by the invention enables user to download pictures from the Internet, digital camera, or storage device (e.g., hard disk or floppy disk) based on needs by executing image processing software. Then review the pictures. Next, user may manipulate a mouse for clicking each of thumbnails 30 and moving the same to an associated picture management object 20. As a result, thumbnails 30 are sequentially embedded into empty picture frames 21 of a picture management object 20. As such, user does not need to repeatedly edit respective graphics file name (or location of graphics file). By utilizing this, it is possible of easily and efficiently editing pictures. As a result, both time and labor are saved as well as provides a user friendly operating environment with respect to the editing of digital image representations.

While the invention has been described by means of specific embodiments, numerous modifications and variations could be made thereto by those skilled in the art without departing from the scope and spirit of the invention set forth in the claims.

What is claimed is:

1. A picture moving and positioning method in an image processing software installed in a computer, after the image processing software is activated, the method comprising the steps of:
showing a desktop for placing a plurality of thumbnails on a screen of the computer; and
showing at least one picture management object on the desktop, each picture management object having a plurality of sorted picture frames wherein as the thumbnails being selected and moved from the desktop to the picture management object by manipulating input means connected to the computer, the thumbnails are sequentially embedded into empty ones of the picture frames of the picture management object.

2. The method of claim 1, further comprising at least one function key on the desktop being operable to open the picture management object on the desktop by clicking the input means to select the function key.

3. The method of claim 1, wherein the image processing software performs the following steps to embed the selected thumbnails into empty ones of the picture frames of the picture management object sequentially:
detecting and reading a location of a cursor of the input means while the selected thumbnail being moved to a last location;
determining whether the cursor is within an area covered by the picture management object;
determining whether there is any of the picture frames in the picture management object not containing any of the thumbnails, if the cursor is within the area covered by the picture management object; and
sequentially embedding each of the thumbnails into each of the empty picture frames of the picture management object, if there are picture frames in the picture management object not containing the thumbnails.

4. The method of claim 3, wherein further comprising the steps of:
determining whether there is any selected thumbnail not being embedded into the picture frames in the picture management object;
opening a second picture management object, if there is any selected thumbnail left; and
sequentially embedding each of the selected thumbnails left into each of the empty picture frames of the second picture management object.

5. The method of claim 3, wherein if the cursor is not within the area covered by the picture management object, the method further comprising the step of positioning the selected thumbnails in the desktop again.

6. The method of claim 1, wherein each of the picture management objects is an electronic album having at least one page each having a plurality of sorted picture frames so that when the album is opened the method further comprises the steps of:
opening another page after all picture frames of one page are embedded with thumbnails;
opening another album after all pages of one album are embedded with thumbnails; and
repeatedly performing the above steps until all the selected thumbnails being moved and embedded into the picture management objects.

7. The method of claim 1, wherein when the image processing software is activated to establish the picture management object in the desktop, an index table is created for the picture management object so that as one of the thumbnails moves to the picture management object for being received therein, information about a graphics file corresponding to the thumbnail will be stored in the index table.

8. The method of claim 7, wherein information about the graphics file comprises a file name and a root directory corresponding to the thumbnail being stored in storage means coupled to the computer.

9. The method of claim 7, wherein when the input means is manipulated to click the thumbnail in the picture frame, the image processing software directly reads the graphics file from a location corresponding to the thumbnail by referring the index table, and maximizes and shows the read graphics file in a browsing window available by the image processing software.
